(19) United States
(12) Patent Application Publication
(10) Pub. No.: US 2009/0100214 A1
(43) Pub. Date: Apr. 16, 2009

(54) Management Platform For Extending Lifespan Of Memory In Storage Devices

(76) Inventors: Bei-Chuan Chen, Hsinchu (TW); Li-Hsiang Chan, Hsinchu (TW); Po-Hsun Wu, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/871,172

(22) Filed: Oct. 12, 2007

(51) Int. Cl. G06F 12/02

(52) U.S. Cl. 711/103; 711/E12.008

(57) ABSTRACT

A management platform for extending lifespan of memory, such as SD, MMC, micro SD, of storage devices is provided. The memory includes a plurality of virtual access units, and a virtual block is defined to include a fixed number of virtual access units. In the management platform, a memory control unit tallies the number of operations performed on a virtual access unit when the virtual access unit is selected to perform on. A processing unit determines whether the data stored in virtual access units should be move to another virtual access unit according to an operation threshold in order to prevent from data loss caused by the memory damage.

### FIELD OF THE INVENTION

The present invention generally relates to a management platform for extending memory lifespan, and more specifically to a management platform for extending lifespan of memory in storage devices.

### BACKGROUND OF THE INVENTION

The current industrial computer embedded systems usually use flash memory based CF, USB disk on module (DOM) memory module, SATA DOM memory module, solid state disk (SSD) solid state harddisk or SATA SSD solid state harddisk, and so on for storage media.

Flash memory mainly consists of a plurality of transistor memory cells, and the data access is through Fowler-Nordheim tunneling to achieve data storage or deletion. A large current usually passes the dielectric layer on the side of floating gate (FG) of the transistor memory cells during the data access.

Therefore, the transistor memory cells will start to malfunction after exceeding a certain number of write/erase operations. Although the limit of write/erase operations is in the range of hundreds of thousands, or even millions before the errors begin to appear, this still implies that the flash memory based storage device still face the possibility of unexpected damage. Therefore, the user cannot trust important data to a single flash memory based storage device. This will affect the development of flash memory based storage device.

In general, to extend the lifespan of flash memory card, the conventional approach is to achieve data access objectives while reducing the number of write/erase operations to postpone reaching the upper write/erase limit, say a hundred thousand times. However, postponing the reaching of the limit is only a matter of time, what is more important is that the user data can be stably maintained before reaching the lifespan of the memory so that the user can move the data to other storage devices.

### SUMMARY OF THE INVENTION

The primary object of the present invention is to provide a management platform for extending lifespan of memory of storage devices. The management platform allows the user to select either automatically or manually to operate the platform function according to the damage of the storage unit, so that the data will not be lost due to the storage unit damage.

To achieve the above object, the present invention provides a management platform for extending lifespan of memory of storage devices. The management platform manages the memory of the storage devices. The memory includes a plurality of virtual access units, and a certain number of virtual access units are defined as a virtual block. In the management platform of the present invention, the memory control unit will tally the number of write/erase operations performed on the selected virtual access unit when the write/erase operation is performed on the selected virtual access unit. The processing unit determines whether the data stored individually in a plurality of virtual access units requires to be removed from original virtual access unit according to the operation threshold.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a management platform for extending lifespan of the memory of storage devices according to the present invention;

FIGS. 2A-2B show a schematic view of a memory management method according to the present invention;

FIG. 3 shows another schematic view of the management platform for extending lifespan of the memory of storage devices according to the present invention; and

FIGS. 4A-4C show yet another schematic view of the management platform for extending lifespan of the memory of storage devices according to the present invention.

### DETAILED DESCRIPTION OF THE PREFERRED EMBODIMENTS

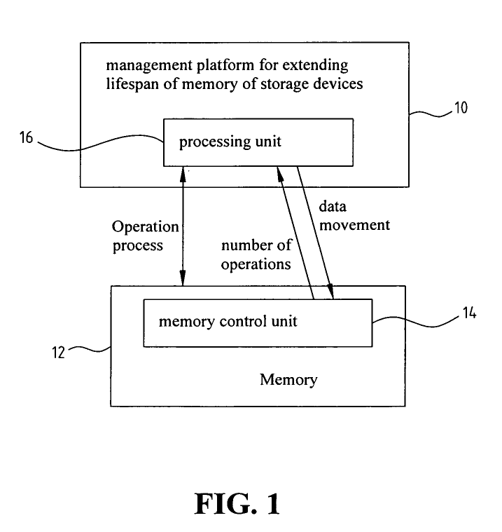

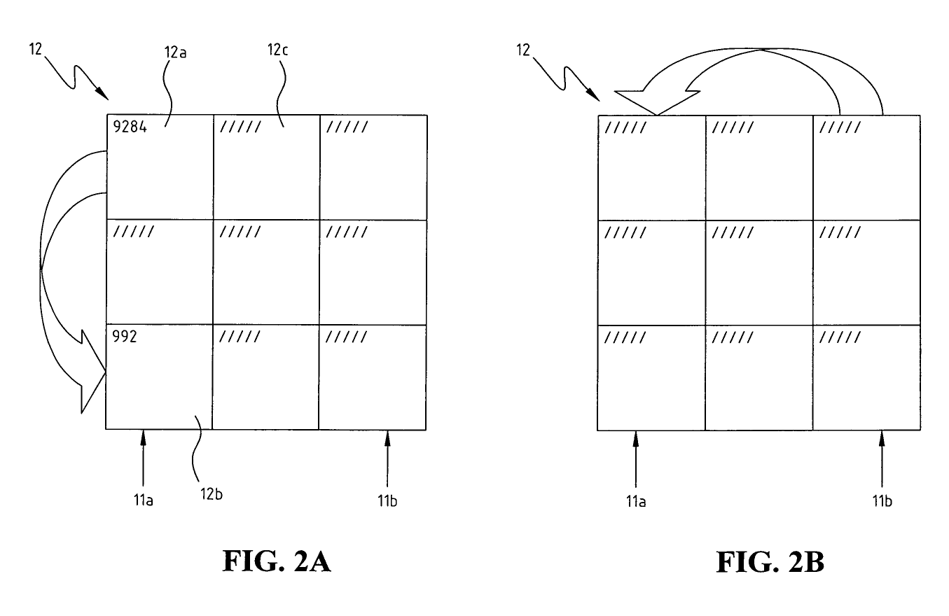

FIG. 1 shows a schematic view of a management platform for extending lifespan of memory of storage devices. As shown in FIG. 1, a management platform 10 of the present invention includes a memory control unit 14 and a processing unit 16. Memory control unit 14 is for performing read, write, program and erase operation on a plurality of virtual access units 12a-12c (as shown in FIG. 2A) of memory 12.

FIGS. 2A-2B show a schematic view of the memory management method of the present invention. As shown in FIGS. 2A-2B, memory 12 includes a plurality of virtual access units 12a-12c, and a virtual block 11a, 11b is defined to include a fixed number of virtual access units.

To achieve the management objectives, management platform 10 must maintain the number of operations performed on virtual access unit 12a-12c. In management platform 10, memory control unit 14 tallies the number of write/erase operations performed on selected virtual access unit 12a when operating on virtual access unit 12a for management platform 10 to adjust the location of access units. For example, as shown in FIG. 2A, virtual access unit 12a is operated on for 9284 times, and virtual access unit 12b is operated on for 992 times. When processing unit 16 perform the erase operation on virtual access unit 12a, the number of erase operations performed on virtual access unit 12a is tallied, and an operation threshold is defined to be the target number of erase operations.

Hence, through management platform 10, the user may operate processing unit 16 according to the operation threshold, and the numbers of operations on a plurality of virtual access units 12a-12c to determine whether the data separately stored in virtual access units 12a-12c needs to be moved from virtual access units 12a-12c to prevent from data loss caused by virtual access unit damage.

As the example shown in FIG. 2A, according to the number of operations performed on virtual access units 12a, 12b of virtual block 11a, processing unit 16 moves the data stored in virtual access unit 12a, which has the number of operations, such as 9284 times, exceeding the operation threshold, to virtual access unit 12b, which has the number of operations less than the operation threshold.

As the example shown in FIG. 2B, if the virtual access units of virtual block 11b have the numbers of operations all greater than the operation threshold, processing unit 16 will move the data stored in virtual block 11b to virtual block 11a which has numbers of operations less than the operation threshold. In particular, the data is moved to virtual block 11a with average number of operations less than the operation threshold.

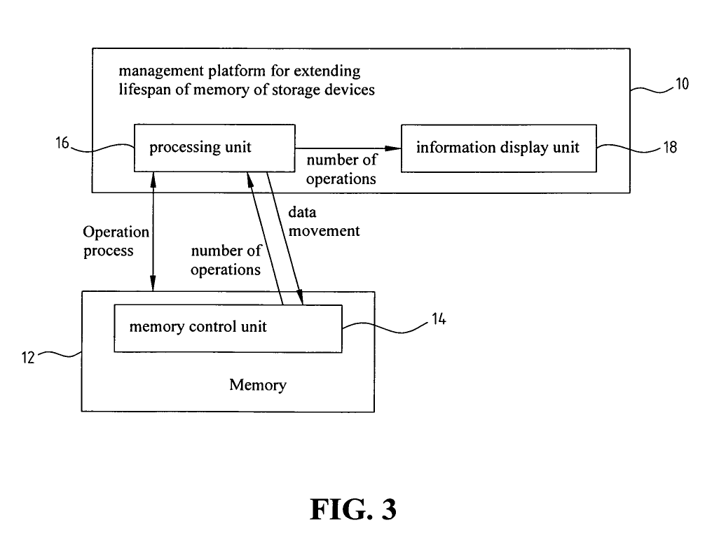

FIG. 3 shows another schematic view of management platform 10 for extending lifespan of memory of storage devices of the present invention, including a memory control unit 14, a processing unit 16 and a information display unit 18. As shown in FIG. 3, the present invention allows the user to know the status of the memory.

Based on the tallied number of operations performed on the virtual access units recorded by memory control unit 14, information display unit 18 displays the operation numbers on the virtual access units in virtual blocks and corresponding virtual access units to let the user know the numbers and the distribution of operations performed on entire memory 12.

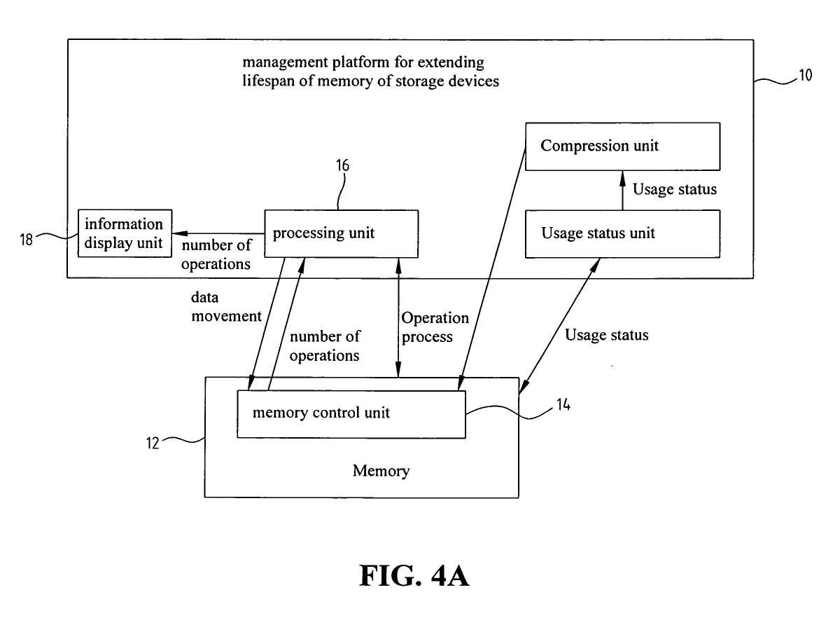

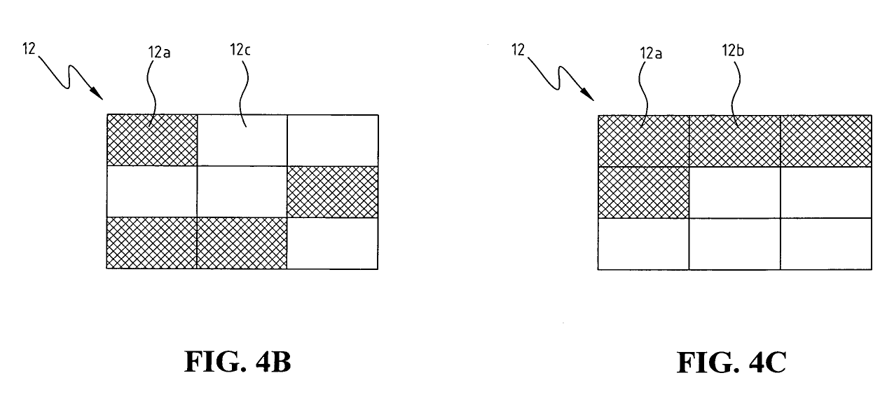

FIGS. 4A-4C show yet another schematic view of the management platform for extending the memory of storage devices, including as a memory control unit 14, a processing unit 16, a usage status unit 20, and a compression unit 22. The present invention allows the user to know the status of memory usage as well as operate the data rearrangement.

As shown in FIG. 4B, usage status unit 20 detects the usage status of virtual access units of virtual blocks 12a, 12c. For example, the usage status of virtual block 12a is used, and the usage status of virtual block 12c is unused.

To improve the access efficiency of memory 12, based on the usage status of virtual access units of each virtual block, compression unit 22 can rearrange the data stored in virtual access units more concentrated, as shown in FIG. 4C, so that the unused virtual block 12c is full of data from other units.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A management platform for extending lifespan of memory of storage devices, said memory comprising a plurality of virtual access units, and defining a virtual block to comprise a certain number of said virtual access units, said management platform comprising:
a memory control unit, for performing read, write, programming and erase operation to said virtual access units, and tallying the number of operations performed on said virtual access units when performing said operations; and
a processing unit, based on an operation threshold, for determining whether the data stored in said virtual access units needing to be moved from said original virtual access units.

2. The management apparatus as claimed in claim 1, wherein said memory control unit tallies the number of said erase operations when performing on selected said virtual access unit, and said operation threshold corresponds to a target number of said erase operations.

3. The management platform as claimed in claim 1, wherein based on said number of said operations on said virtual access units of said same virtual block, said processing unit moves data in said virtual access units with said number of said operations higher than said operation threshold to virtual access units with said number of said operations lower than said operation threshold.

4. The management platform as claimed in claim 1, wherein when the average of said numbers of said operations of said virtual access units of said virtual block is higher than said operation threshold, said processing unit moves data in said virtual block with said average number of said operations higher than said operation threshold to virtual block with said number of said operations lower than said operation threshold.

5. The management platform as claimed in claim 4, wherein said data is moved to virtual block with said average number of said operations lower than said operation threshold.

6. The management platform as claimed in claim 1, further comprising:
an information display unit, based on said tallied number of operations performed on said virtual access units recorded by said memory control unit, for displaying said number of said operations of said virtual access units in the manner of said virtual block mapping said virtual access units.

7. The management platform as claimed in claim 1, further comprising:
a usage status unit, for detecting a usage status of each said virtual access unit of each said virtual block, said usage status comprising at least used and unused; and
a compression unit, for re-arranging data in said virtual access units more concentrated according to said usage status of said virtual access unit of said virtual block.
